(19) United States
(12) Patent Application Publication
(10) Pub. No.: US 2019/0034900 A1
(43) Pub. Date: Jan. 31, 2019

(54) MODULAR ELECTRONIC FUNDS TRANSFER POINT OF SALE DEVICE

(71) Applicant: BBPOS LIMITED, HONG KONG (HK)

(72) Inventors: CHI WAH LO, HONG KONG (HK); HWAI SIAN TSAI, HONG KONG (HK)

(21) Appl. No.: 16/046,521

(22) Filed: Jul. 26, 2018

Related U.S. Application Data
(60) Provisional application No. 62/538,285, filed on Jul. 28, 2017.

(51) Int. Cl. G06Q 20/20; G06Q 20/40; G06Q 20/34

(52) U.S. Cl. CPC G06Q 20/204; G06Q 20/34; G06Q 20/4012

(57) ABSTRACT

A point-of-sale device comprises a card reading interface module configured to read card information from a payment card and a card holder authentication module, coupled to the card reading interface module. The card holder authentication module receives the card information from the card reading interface module and authenticates a financial transaction. The card reading interface module is certified against a card holder authentication security standard and the card holder authentication module is certified against a card reading security standard.

### CROSS-REFERENCE TO RELATED APPLICATIONS

This application claims the benefit of U.S. Provisional Application No. 62/538,285, filed Jul. 28, 2017 (Atty. Dkt. No. BBPS-33616), the specification of which is incorporated herein by reference in its entirety.

### TECHNICAL FIELD

The following disclosure relates to electronic funds transfer and more particularly to the use of a point of sale terminal to facilitate the funds transfer.

### BACKGROUND

In order to securely accept payment using a financial, credit, or debit card, a terminal is commonly used. These terminals are often referred to as Electronic Fund Transfer Point-of-Sale (EFTPOS) terminals or simply as Point-of-Sale (POS) terminals. EFTPOS terminals can be viewed as supporting two distinct functions: card reading and card holder authentication.

Card reading comprises reading secure data from a financial card at a point of interaction. Financial cards can support one or more forms of data storage and transfer such as magnetic stripe cards, Europay Mastercard Visa (EMV) compliant chip cards, contactless chip cards, and phone card emulation mode. The information stored within a financial card enables the identification of the card, either by account number such as a payment card number, a Primary Account Number (PAN), a representative token, or other method. The card reader can further authenticate a chip card by using cryptographic measures such as offline-data-authentication. The interoperability between card readers and cards are ensured by industrial standards such as EMV, and account privacy protection can be evaluated against industrial standards such as PCI Secure Reading and Exchange of Data (SRED).

Card holder authentication is usually the merchant's responsibility, either by requesting a user to enter a personal identification number (PIN) on a PIN pad, or to sign a signature on paper or screen. Newer implementations also include the card holder side authentication, in particularly for mobile phone based card emulation and/or electronic wallets. Authentication compliance is governed by standards such as PCI PIN Transaction Security (PTS).

Currently, EFTPOS terminals embed the card reading and the card holder authentication functionalities into a single device. The entire device is then certified against relevant payment security and interoperability standards. Further modification of the terminal is likely to affect the compliance of the unmodified functional parts, often requiring a recertification of the entire device. Moreover, configuring the terminal to address different merchant needs is difficult. For example, some merchants may only need to accept card payment without PIN support, but the PIN pad in the terminal may account for a significant portion of the total cost of the terminal.

In some examples, existing EFTPOS terminals can work with external modules. For example, a contactless card reader can be added to an existing EFTPOS terminal which does not support contactless card reading, or a PIN pad which is compliant with the relevant standards can be added to existing EFTPOS terminals which are not compliant in order to ensure compliance of the whole system. Nevertheless, despite having an expandable design, it is still not a modular architecture.

Other than EFTPOS terminals, there are some other kinds of terminals which are designed to be more modular. For example, an Automatic Teller Machine is designed to integrate a PIN pad module and card reader module into its chassis.

However, regardless of the different forms and variations of above mentioned devices and modules, a common design methodology is designing devices only to handle the task that the devices are supposed to perform. This is done in order to reduce the complexity of development, the scope of certification, and the cost of the device. For example, a card reading device will commonly be evaluated against interoperability evaluations, such as those proposed by EMVCo, and account data security standards such as PCI SRED. An authentication module such as a PIN pad will commonly be evaluated against security standards such as PCI PTS.

There exists a need for a modular architecture that may be used with an EFTPOS terminal to allow for the flexible implementation of both card reading and card holder identification without requiring additional compliance testing.

Other aspects and features of the present invention will become apparent to those ordinarily skilled in the art upon review of the following description of specific embodiments of the invention in conjunction with the accompanying figures.

### SUMMARY

Embodiments of the invention include a point-of-sale device that comprise a card reading interface module configured to read card information from a payment card. A card holder authentication module, coupled to the card reading interface module, receives the card information from the card reading interface module and authenticates a financial transaction. In some embodiments, the card reading interface module is certified against a card holder authentication security standard. In other embodiments, the card holder authentication module is certified against a card reading security standard.

In other embodiments, the card information is encrypted by the card reading interface module prior to transmitting the card information to the card holder authentication module.

In other embodiments authenticating a financial transaction comprises receiving user authentication information and performing offline authentication utilizing the payment card.

In further embodiments authenticating a financial transaction comprises receiving user authentication information and transmitting modified user authentication information to an external authentication server, where the card holder authentication module receives an authentication confirmation from the external authentication server.

In other embodiments, the card holder authentication module processes the card information to construct a PIN block. The PIN block and the card information is used to produce modified card information and the modified card information is used to authenticate the financial transaction.

In other embodiments, the card holder authentication module processes the card information to construct a PIN block. The PIN block and the card information is used to produce modified card information. The modified card information is used to authenticate the financial transaction.

Other embodiments of the invention include a method of authenticating a financial transaction. The method comprises a card reading interface module receiving card information from a payment card. A card holder authentication module, coupled to the card reading interface module, receives the card information from the card reading interface module. In response to receiving the card information, the card holder authentication module computes modified card information. The modified card information comprises a PIN Block utilizing the card information. The card holder authentication module receives authentication credentials of a user and authenticates the financial transaction.

Some embodiments further comprise the card holder authentication module transmitting the modified card information to an external server. The external server receives the modified card information and returns an authorization to the card holder authentication module.

Further embodiments comprise the card holder authentication module transmitting the modified card information to the card reading interface module. The card reading interface module receives the modified card information and transmits it to the payment card. The payment card receives the modified card information and returns an authorization to the card reading interface module.

Other further embodiments comprise the card information being encrypted by the card reading interface module before transmitting the card information to the card holder authentication module.

In other embodiments, the authentication credentials are encrypted by the card holder authentication module before transmission to the card reading interface module.

In other embodiments, the modified card information is encrypted before transmission external to the card reading interface module or external to the card holder authentication module.

Further major embodiments include another method of authenticating a financial transaction. The method comprises a card holder authentication module receiving authentication credentials of a user. A card reading interface module, coupled to the card holder authentication module, receives the authentication credentials from the card holder authentication module. The card reading interface module transmits the authentication credentials to a payment card coupled to the card reading interface module. The card reading interface module receives card information from the payment card and computes modified card information. The modified card information comprises a PIN Block utilizing the card information. The card reading interface module transmits the modified card information to an external server. The external server receives the modified card information and returns an authorization to the card reading interface module.

In some embodiments, the card reading interface module is certified against a card holder authentication security standard. In other embodiments, the card holder authentication module is certified against a card reading security standard.

In further embodiments, the authentication credentials are encrypted by the card holder authentication module before transmission to the card reading interface module.

In other further embodiments, the modified card information is encrypted by the card reading interface module before transmission to the external server.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

For a more complete understanding, reference is now made to the following description taken in conjunction with the accompanying Drawings in which:

FIG. 1 depicts the general architecture of embodiments of the invention with the directions of possible data flow illustrated;

FIG. 2 depicts an example of one implementation supporting one exemplary embodiment of the invention;

FIG. 3 depicts a flowchart of operation of the architecture of FIG. 2;

FIG. 4 depicts an example of another exemplary embodiments of the invention; and

FIG. 5 depicts a flowchart of operation of the architecture of FIG. 4.

### DETAILED DESCRIPTION

Embodiments of the invention comprise a system and method for a modular EFTPOS terminal architecture. The EFTPOS comprises two separate modules implementing a card reading interface and card holder authentication, the two major functions of an EFTPOS. The card reading interface module adheres to industry standards and is able to process the PIN, signature, or other authentication data. The card holder authentication module is compliant with the relevant standards so as to allow processing of the card account data.

Card reading interface standards include PCI Secure Reading, Exchange of Data (SRED), and Payment Card Industry (PCI) Point to Point Encryption (P2PE).

Card holder authentication standards include PCI PIN Transaction Security (PTS).

Both modules receive certifications as required. The card reading interface module is required to be compliant with card holder authentication security standards such as PCI PIN Transaction Security (PTS), but is also compliant with account data security standards such as Payment Card Industry (PCI) Point to Point Encryption (P2PE). Similarly, the card holder authentication module is certified compliant with both card holder authentication security standards and account data security standards. In other words, each module is certified for the standards it requires for its functionality as well as for the standards required for the functionality of the other module. This architecture offers the flexibility to allow the card reading interface module to process the PIN, and the card authentication module to process card and account data. This modular design allows the EFTPOS system to be used together or with other devices. This avoids the problem of having to re-certify the entire EFTPOS system if one of the modules needs to be replaced. In the case of replacement, only the new module needs to be certified and not the entire system which reduces the time and cost of recertification.

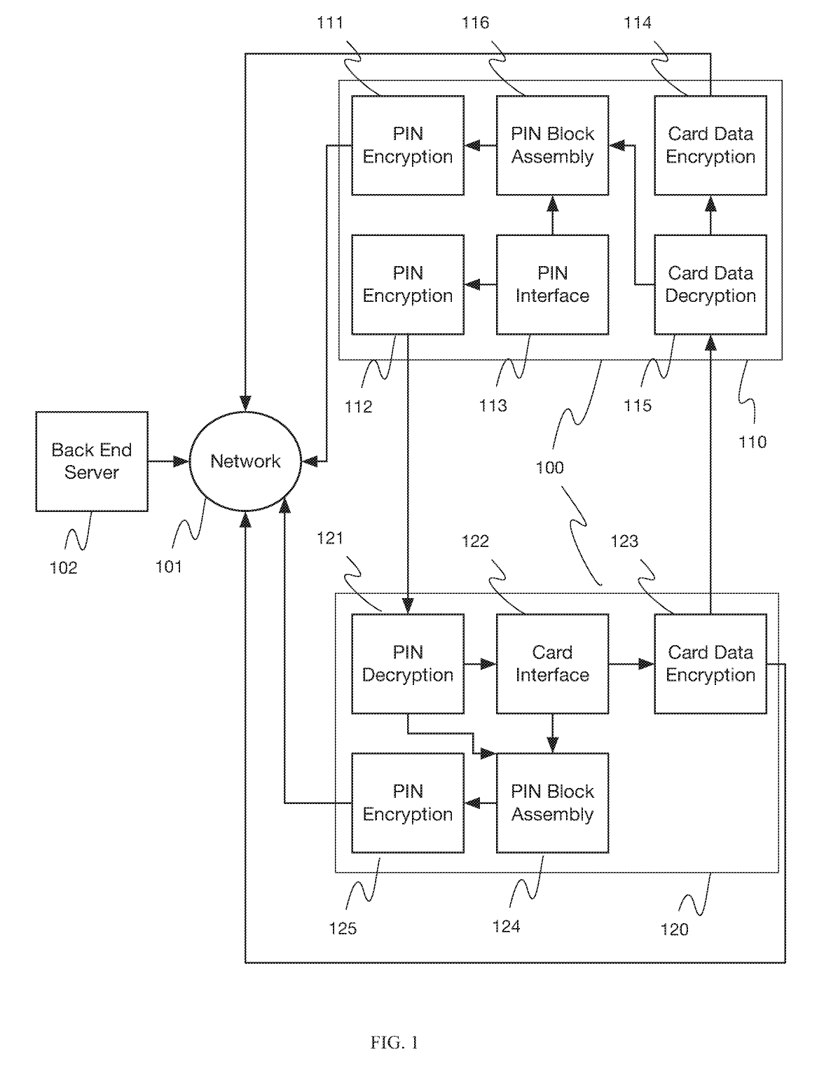

FIG. 1 shows a general architecture of embodiments of the invention. Arrows show the directions of different possible data flow. Back-end server 102 performs functions such as acquiring and processing the payment transaction. It is coupled via network 101 to system 100 which comprises card holder authentication module 110 and card reading interface module 120. In this embodiment, back-end server 102 is coupled to modules 110 and 120 via network 101. In other embodiments, module 120 is connected with back-end server 102 via module 110 and network 101. In another embodiment, module 110 is connected to back-end server 102 via module 120 and network 101. In a further embodiment, module 110 and module 120 are coupled to network 101 via additional communication devices, not shown.

Network 101 may be implemented in a variety of ways known to those of skill in the art. For example, in one embodiment, network 101 comprises one or more subnetworks. In some embodiments, network 101 comprises at least one private network. In yet other embodiments, network 101 comprises at least one public network. In another embodiment, network 101 is implemented using one or more types of networks known to those of skill in the art. These types of networks include, for example, wireless networks, wired networks, Ethernet networks, local area networks, metropolitan area networks and optical networks.

Module 110 is a card holder authentication module which accepts card holder authentication data such as a PIN, or an electronic signature, biometric features, or any combinations of authentication data. While the rest of this specification will describe embodiments which use a PIN for authentication, it would be known to one of skill in the art that authentication using other identification factors is also possible using similar system architectures. In exemplary embodiments, module 110 comprises PIN encryption 111, PIN encryption 112, card data encryption 114, card data decryption 115, PIN interface 113 and PIN block assembly 116. PIN interface 113 serves to read PINs entered into module 110, before transmission to PIN encryption 111. PIN encryption 111 is coupled to back-end server 102 via network 101. It serves to encrypt PINs received from PIN block assembly 116 before transmission to back-end server 102 for online PIN authentication. PIN encryption 112 serves to encrypt PINs received from PIN interface 113 before transmission to PIN decryption 121 on module 120. This enables PIN data to be transferred from module 110 to module 120 securely, and allows module 120 to make use of the PIN for offline PIN authentication with the card, or to be re-encrypted and sent to backend server 102 for online PIN authentication. Card data encryption 114 is coupled to back-end server 102 via network 101 as explained above. It serves to encrypt card data before transmission to back-end server 102. Card data decryption 115 serves to receive and decrypt encrypted card data sent from card data encryption 123 residing on module 120. PIN block assembly takes place in PIN block assembly 116. PIN block assembly comprises using the card data for purposes such as constructing a PIN block in a format that requires the account number and repackaging the PIN in a different format so as to adapt to the processing requirements of the back-end server 102.

Module 120 is a card reading interface module. Module 120 comprises, PIN decryption 121, card interface 122, card data encryption 123, PIN block assembly 124 and PIN encryption 125. PIN decryption 121 serves to receive and decrypt encrypted PINs received from PIN encryption 112. Card interface 122 serves to read card data from a financial card. Card data encryption 123 serves to encrypt card data received from card interface 122 according to cryptographic standards before transmission to card data decryption 115 on module 110. In one embodiment, data is sent from card data encryption 123 to back-end server 102 via network 101. PIN block assembly 124 is used in embodiments where PIN block assembly is performed in module 120. This plays a similar role to PIN block assembly 116. PIN encryption 125 plays a similar role to PIN encryption 111. It is also coupled to back-end server 102 via network 101.

In one embodiment, modules 110 and 120 are physically located within an EFTPOS terminal and connected by a serial connection or other communications interface. The EFTPOS terminal may have other modules and devices such as printer and communication modules. In another embodiment, modules 110 and 120 are physically separate devices but are coupled together communicatively using a wireless technology such as Bluetooth. In some embodiments, the connection between PIN encryption 112 and PIN decryption 121, and the connection between card data encryption 123 and card data decryption 115 may occupy a single bidirectional, or multiplexed communications channel. In a further embodiment, the connections between module 110 and network 101, and between module 120 and network 101 are implemented using a common communications module. This communications module may be located in either module 110 or module 120, or may be an additional device, and coupled to network 101.

In some embodiments, the PIN, card and other sensitive data exchanged between modules 110 and 120 are protected via one or more cryptographic schemes. PIN encryption 112 and PIN decryption 121 are used to encrypt and decrypt PIN data, whereas card data encryption 123 and card data decryption 115 are used to encrypt and decrypt card data.

In a further embodiment, the communication channels between modules 110 and 120 are sufficiently secure that encryption is not necessary. In these embodiments, PIN encryption 112, PIN decryption 121, card data encryption 123 and card data decryption 115 may be omitted. In another embodiment, a single secure bidirectional channel is set up between modules 110 and 120, and all sensitive data including PIN and card data are transmitted securely over this single bidirectional connection.

If the encrypted data received by one module from the other module is not used, then the encrypted PIN data can be sent to the back-end server 102 without decryption and re-encryption. In some embodiments, module 120 uses module 110 to communicate with back-end server 102 via network 101. That is, the encrypted card data sent from card encryption 123 on module 120 is not used by module 110. Then the cryptographic scheme used to encrypt transmissions between card encryption 123 and back-end server 102 is established without utilizing card data decryption 115 and card data re-encryption 114.

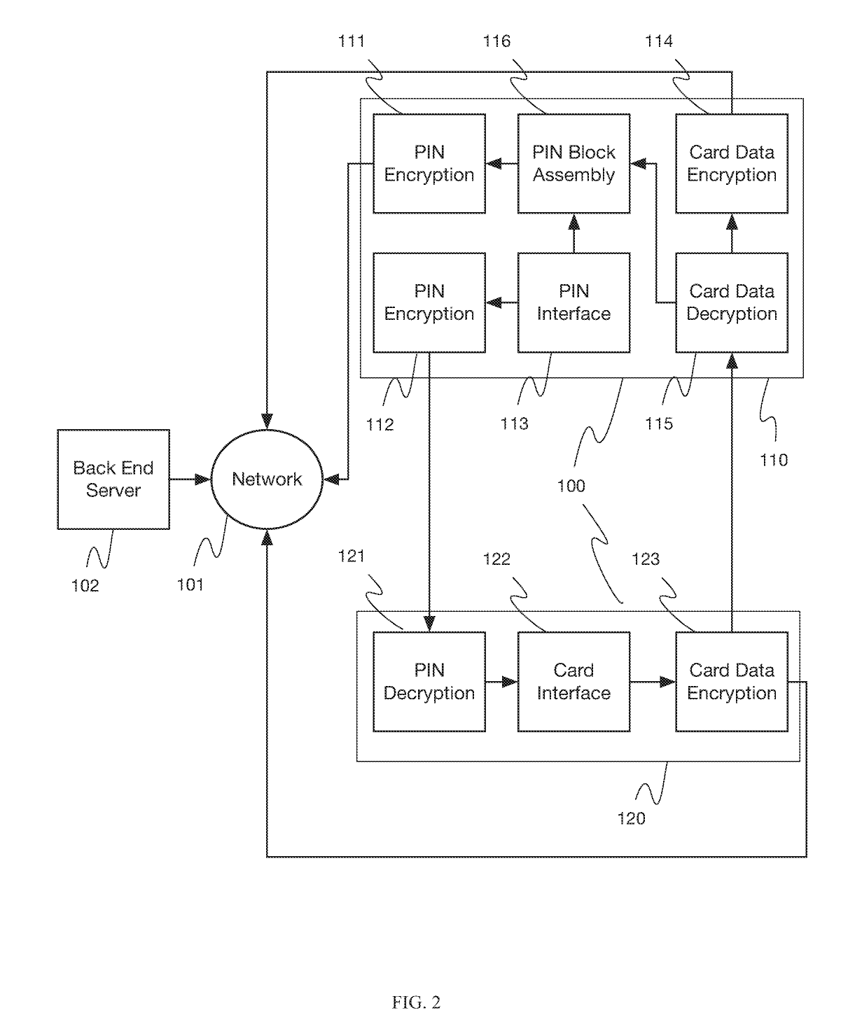

There are many possible implementations for modules 110 and 120. FIG. 2 is a block diagram of one embodiment of the system and method. In this embodiment, the PIN Block Assembly 124 and PIN Encryption 125 features of the embodiment of FIG. 1 have been removed from card reading interface 120.

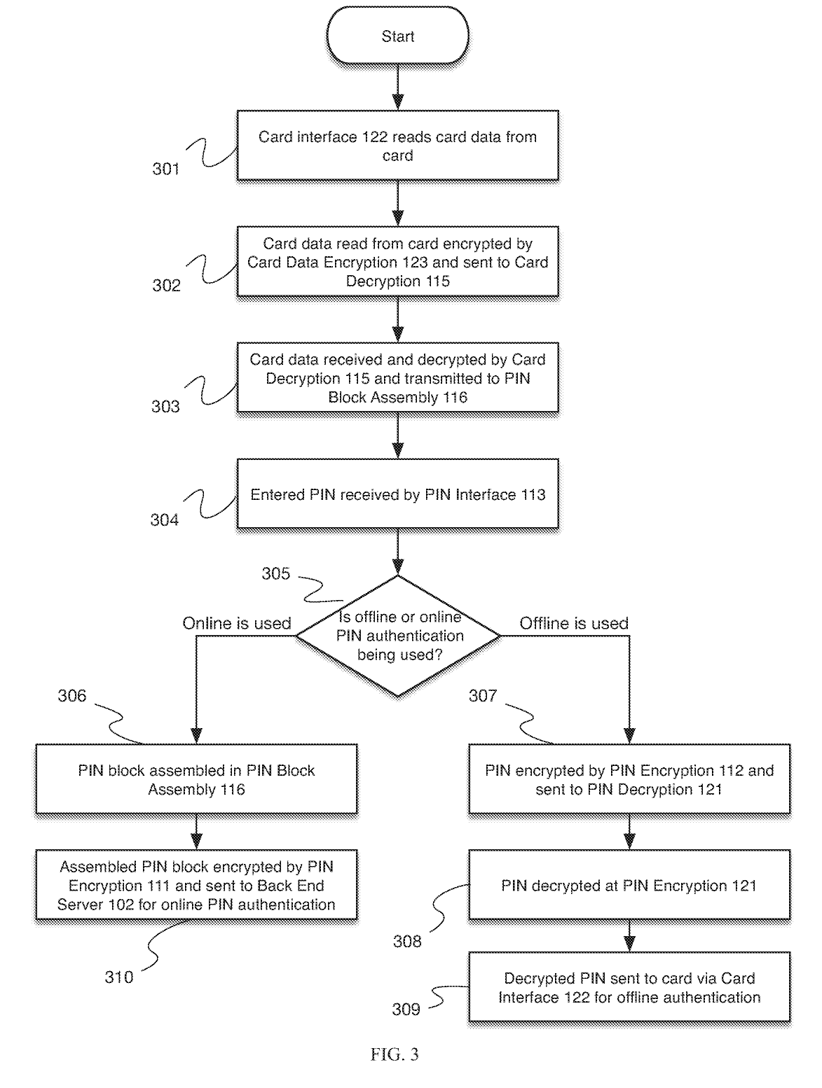

FIG. 3 shows a flowchart of operation for the architecture shown in FIG. 2. In step 301, card interface 122 on module 120 reads card data from a user's financial card. In step 302, this card data is encrypted by card data encryption 123 and sent to card decryption 115 on module 110. In step 303, the card data is received and decrypted by card data decryption 115 before being transmitted to PIN block assembly 116. In step 304, the card holder enters a PIN which is received by PIN interface 113. The PIN data can then take one of two possible routes 305 depending on whether offline PIN authentication or online PIN authentication is being used.

In embodiments where online PIN authentication is used, in step 306, PIN block assembly using the PIN and card data is performed in PIN assembly block 116. In step 310, the PIN block is encrypted by PIN encryption 111 and sent to back-end server 102 via network 101. This enables the back-end server 102 to contact the issuing bank to perform PIN authentication. As part of step 310, the card data is sent in real-time to the back-end server 102 for issuer approval of the online transaction. In one embodiment, other transaction data is also sent along with the card data to the back-end server 102 for issuer approval.

In embodiments where offline PIN authentication is used, in step 307, the PIN is encrypted at PIN encryption 112 and transmitted to PIN decryption 121 on module 120. In step 308, the PIN is decrypted at PIN decryption 121. In step 309, the decrypted PIN is then sent to the card via card interface 122 for offline PIN authentication. This increases the flexibility of module 120 significantly, as it can now accept and decrypt encrypted PINs; and facilitate offline data authentication. Therefore, it can work with any device that will send an encrypted PIN. In embodiments where online transactions are employed, the card data is sent in real-time to back-end server 102 for issuer approval. Other transaction data may also be sent along with the card data for issuer approval. When offline transactions are employed, the card and other transaction data is optionally, not sent in real-time to the back-end server 102. Instead, the card data and other transaction data are sent in batch mode to the back-end server 102.

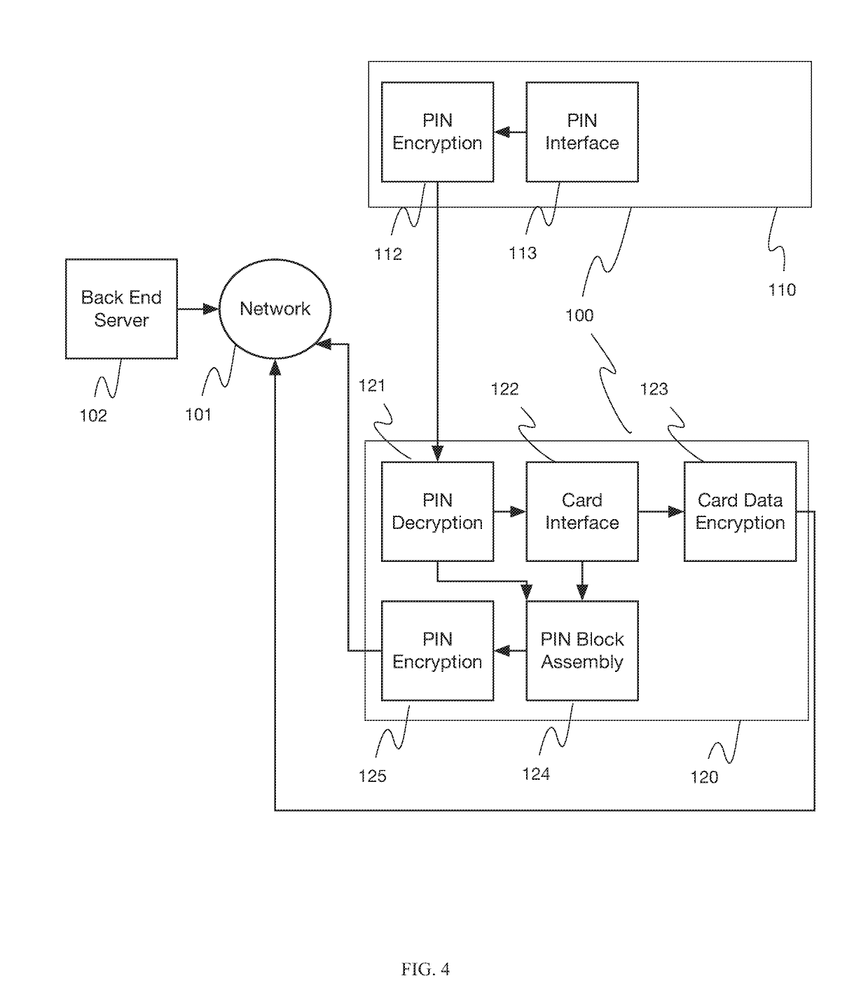

FIG. 4 is an example embodiment where the card holder authentication module 110 does not contain the PIN Encryption 111, Card Data Encryption 114, Card Data Decryption 115, and PIN Block Assembly 116 modules. The module 110 only receives card holder authentication entries data such as PIN or electronic signatures. This corresponds to a situation where a PIN is entered at a device such as a smartphone or a tablet and module 110 is implemented on the smartphone or tablet and card reading interface module 120 is, for example, on a separate stand-alone device.

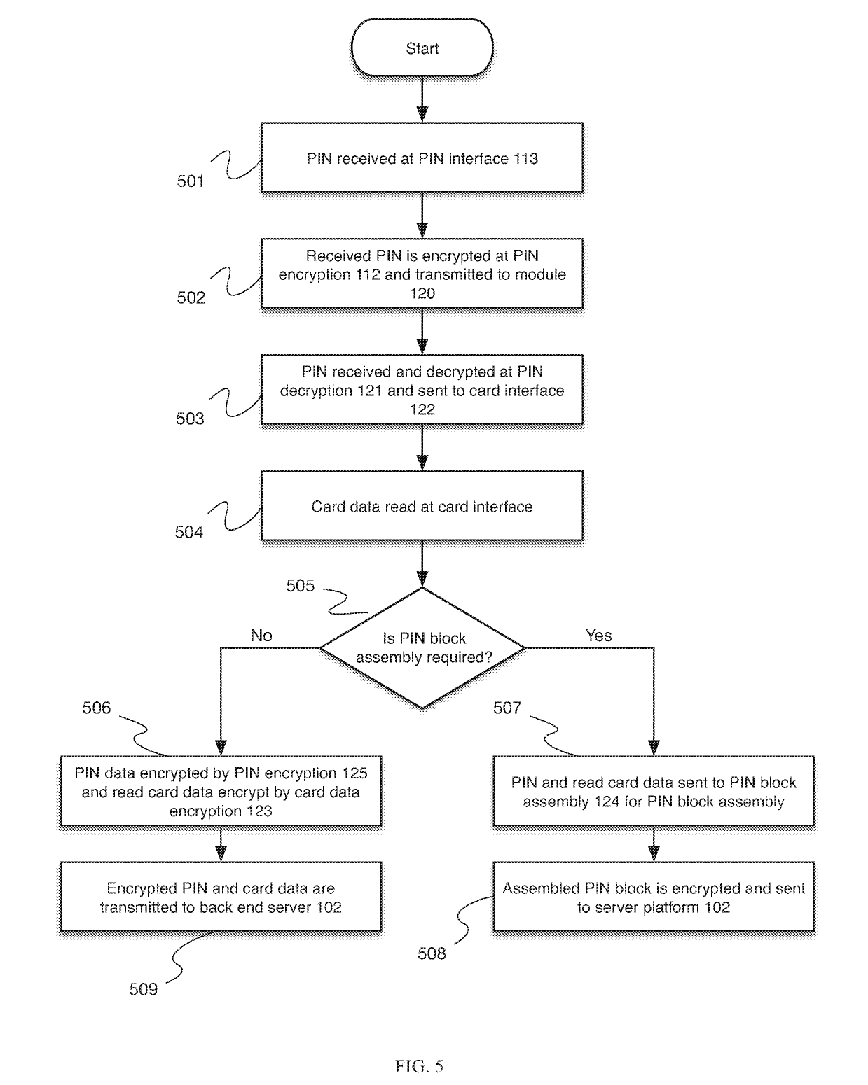

A process flow for the operation of the embodiment of FIG. 4 is shown in FIG. 5. In step 501, a PIN is received at PIN interface 113 via, for example, entry by a user. In step 502, the received PIN is encrypted at PIN encryption 112 and transmitted to module 120. Module 120 performs all the necessary steps for the transaction before transmission to back-end server 102 over network 101. In step 503, the PIN received from PIN encryption 112 is decrypted at PIN decryption 121 and sent to card interface 122. In step 504, the card data is read at card interface 122.

In some embodiments, if PIN block assembly is not required (step 505), then in step 506 the PIN data is sent to PIN encryption 125 where the PIN data is encrypted, and the card data read at card interface 122 is sent to card data encryption 123, where it is encrypted. In step 509, the encrypted PIN and card data are transmitted to back-end server 102 via network 101.

In other embodiments, if PIN block assembly is required (step 505) then in step 507 the PIN along with the card data read at card interface 122 is sent to PIN block assembly 124 where the assembly takes place. In step 508, the assembled PIN block is encrypted at PIN encryption 125 and sent to back-end server 102 via network 101.

By separating the EFTPOS terminal into these two modules, certifying the card reading interface module 120 for PIN processing, and certifying the card holder authentication module 110, containing the PIN pad, for account data processing, the impact of changing one module to the compliance of the other modules and the whole system is minimized, and the flexibility of terminal configuration is greatly enhanced.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Although the preferred embodiment has been described in detail, it should be understood that various changes, substitutions and alterations can be made therein without departing from the spirit and scope of the invention as defined by the appended claims.

What is claimed is:

1. A point-of-sale device comprising:
a card reading interface module to read card information from a payment card; and
a card holder authentication module coupled to the card reading interface module, the card holder authentication module receiving the card information from the card reading interface module and authenticating a financial transaction.

2. The device of claim 1 wherein the card reading interface module is certified against a card holder authentication security standard.

3. The device of claim 1 wherein the card holder authentication module is certified against a card reading security standard.

4. The device of claim 1 wherein the card information is encrypted by the card reading interface module prior to transmitting the card information to the card holder authentication module.

5. The device of claim 1 wherein authenticating a financial transaction comprises receiving user authentication information and performing offline authentication utilizing the payment card.

6. The device of claim 1 wherein authenticating a financial transaction comprises receiving user authentication information and transmitting modified user authentication information to an external authentication server, the card holder authentication module receiving an authentication confirmation from the external authentication server.

7. The device of claim 1 wherein the card holder authentication module processes the card information to construct a PIN block, the PIN block and the card information being used to produce modified card information, the modified card information used to authenticate the financial transaction.

8. The device of claim 1 wherein the card holder authentication module processes the card information to construct a PIN block, the PIN block and the card information being used to produce modified card information, the modified card information used to authenticate the financial transaction.

9. A method of authenticating a financial transaction, the method comprising:
receiving, by a card reading interface module, card information from a payment card;
transmitting, from the card reading interface module, the card information to a card holder authentication module, the card holder authentication module coupled to the card reading interface module;
receiving the card information by a card holder authentication module;
computing, by the card holder authentication module in response to receiving the card information, modified card information comprising a PIN Block utilizing the card information;
receiving, by the card holder authentication module, authentication credentials of a user; and
authenticating, by the card holder authentication module, the financial transaction.

10. The method of claim 9 further comprising:
transmitting, by the card holder authentication module, the modified card information to an external server;
receiving, by the external server, the modified card information; and
returning, by the external server, an authorization to the card holder authentication module.

11. The method of claim 9 further comprising:
transmitting, by the card holder authentication module, the modified card information to the card reading interface module;
receiving, by the card reading interface module, the modified card information;
transmitting, by the card reading interface module, the modified card information to the payment card;
receiving, by the payment card, the modified card information; and
returning, by the payment card, an authorization to the card reading interface module.

12. The method of claim 9 further comprising encrypting the card information by the card reading interface module before transmitting the card information to the card holder authentication module.

13. The method of claim 9 further comprising encrypting the authentication credentials by the card holder authentication module before transmitting to the card reading interface module.

14. The method of claim 9 further comprising encrypting the modified card information before transmission external to the card reading interface module or external to the card holder authentication module.

15. A method of authenticating a financial transaction, the method comprising:
receiving, by a card holder authentication module, authentication credentials of a user;
transmitting, from the card holder authentication module, the authentication credentials to a card reading interface module, the card reading interface module coupled to the card holder authentication module;
transmitting, from the card reading interface module, the authentication credentials to a payment card coupled to the card reading interface module;
receiving, by the card reading interface module card, information from the payment card; and
computing, by the card reading interface module, modified card information, comprising a PIN Block utilizing the card information;
transmitting, by the card reading interface module, the modified card information to an external server,
receiving, by the external server, the modified card information; and
returning, by the external server, an authorization to the card reading interface module.

16. The method of claim 15 wherein the card reading interface module is certified against a card holder authentication security standard.

17. The method of claim 15 wherein the card holder authentication module is certified against a card reading security standard.

18. The method of claim 15 further comprising encrypting the authentication credentials by the card holder authentication module before transmission to the card reading interface module.

19. The method of claim 15 further comprising encrypting the modified card information by the card reading interface module before transmission to the external server.
